(19) United States
(12) Patent Application Publication
(10) Pub. No.: US 2025/0380167 A1
(43) Pub. Date: Dec. 11, 2025

(54) METHODS FOR REVERSE UE-UE CLI MEASUREMENT IN NON-OVERLAPPING SUBBAND-FULLDUPLEX DEPLOYMENT

(71) Applicant: MediaTek Singapore Pte. Ltd., Singapore (SG)

(72) Inventors: Jozsef Gabor NEMETH, Cambridge (GB); Mohammed S Aleabe AL-IMARI, Cambridge (GB); Lung-Sheng TSAI, Hsinchu City (TW); Francesc BOIXADERA-ESPAX, Cambridge (GB)

(21) Appl. No.: 18/876,459

(22) PCT Filed: Jun. 2, 2023
(86) PCT No.: PCT/CN2023/097946

§ 371 Date: Dec. 18, 2024

Related U.S. Application Data
(60) Provisional application No. 63/356,090, filed on Jun. 28, 2022.

(51) Int. Cl. H04W 24/10; H04B 7/06; H04B 17/318; H04B 17/345; H04L 5/14

(52) U.S. Cl. CPC H04W 24/10; H04B 7/06968; H04B 17/328; H04B 17/345; H04L 5/14

(57) ABSTRACT

Techniques pertaining to reverse user equipment to user equipment (UE-UE) cross-link interference (CLI) measurement in non-overlapping subband-fullduplex (SBFD) deployment are described. A UE performs a measurement related to a transmission by another UE in a SBFD deployment. The UE then reports a result of the measurement per receiver (Rx) antenna of a plurality of Rx antennas separately.

### CROSS REFERENCE TO RELATED PATENT APPLICATION(S)

The present disclosure is part of a non-provisional application claiming the priority benefit of U.S. Patent Application No. 63/356,090, filed 28 Jun. 2022, the content of which herein being incorporated by reference in its entirety.

### TECHNICAL FIELD

The present disclosure is generally related to mobile communications and, more particularly, to methods for reverse user equipment to user equipment (UE-UE) cross-link interference (CLI) measurement in non-overlapping subband-fullduplex (SBFD) deployment.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5th Generation (5G) New Radio (NR), SBFD deployment (e.g., with uplink (UL) subbands in certain downlink (DL) slots) can provide certain benefits. For example, there can be lower time-division duplex (TDD) alignment delay, thereby resulting in low latency and more retransmission opportunities for real-time traffic. Additionally, there can be longer UL transmissions, thereby resulting in better coverage by applying UL repetitions for robustness. Moreover, legacy UEs can also enjoy aforementioned benefits. The signal-to-interference-and-noise-ratio (SINR) of DL reception of legacy UEs is not to be affected or jeopardized by UL-DL inter-subband CLI of other UE transmitting in UL-SB of the same slot in the same serving cell. The scheduler needs to learn the level of potential CLI to reception of legacy UEs from other UEs that could potentially be scheduled to transmit in a UL subband of the same slot. However, legacy UEs are not supposed to support the UE-UE CLI measurement feature from Release 16 (Rel-16) of the 3GPP specification or future releases to come. Therefore, there is a need for a solution of reverse UE-UE CLI measurement in a non-overlapping SBFD deployment.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving reverse UE-UE CLI measurement in a non-overlapping SBFD deployment.

In one aspect, a method may involve a UE performing a measurement related to a transmission by another UE in a SBFD deployment. The method may also involve the UE reporting a result of the measurement per receiver (Rx) antenna of a plurality of Rx antennas separately.

In another aspect, a method may involve a UE performing a measurement related to a transmission of a sounding reference signal (SRS) by another UE in a SBFD deployment. The method may also involve the UE reporting a result of the measurement. The UE may be configured with a quasi-collocation (QCL)-Type D spatial relationship of a measurement resource with a physical uplink shared channel (PUSCH) or physical uplink control channel (PUCCH) transmission by the UE.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIOT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reverse UE-UE CLI measurement in a non-overlapping SBFD deployment. According to the present disclosure, a number of possible solutions may be implemented separately or jointly. That is, although these possible solutions may be described below separately, two or more of these possible solutions may be implemented in one combination or another.

In the present disclosure, the term “subband” or “cluster” may refer to a contiguous set of resource blocks (RBs) sharing the same link direction. The term “group of RBs” or “RB set” may refer to a set of contiguous RBs within a carrier and should be distinguished from the existing concept of “RB sets” in Release 17 (R17) of the 3GPP specification regarding New Radio unlicensed band (NR-U), which are used in wideband operation over shared spectrum. The concept of cluster availability is based on listen-before-talk in R17 while, in R18, cluster availability for sending or receiving is based on a periodic subband layout pattern. In R17, all UEs use the same cluster availability, whereas in R18, cluster configurations may be different per UE. Moreover, non-contiguous cluster operation is not allowed in R17, whereas in R18, non-contiguous cluster operation needs to be supported. Furthermore, in R18, it is assumed that there is co-existence of legacy UEs (time-division duplexing (TDD)) and enhanced UEs (SBFD-aware). The term “CLI” may refer to cross-link interference (e.g., UE/UL-to-UE/DL, gNB/DL-to-gNB/UL). The term “SIC” may refer to self-interference cancellation on the gNB side. The term “CC” may refer to component carrier in the context of carrier aggregation (CA) or multi-carrier duplexing. The term “RateMatchPattern” may refer to a concept used by the 3GPP standard to define a frequency-time region and its repetitions (called a pattern) over the network resources that are excluded from those network resources used by a DL transmission scheduled in an overlapping region. To send the same payload over less resources, the coding rate needs to be matched. The term “active UE DL cluster” may refer to a cluster that is schedulable for a UE in a given slot when the UE is receiving. The term “active UE UL cluster” may refer to a cluster that is schedulable for a UE in a given slot when the UE is transmitting. The term “active UE cluster” may refer to any DL or UL cluster that is schedulable for the UE in a given slot.

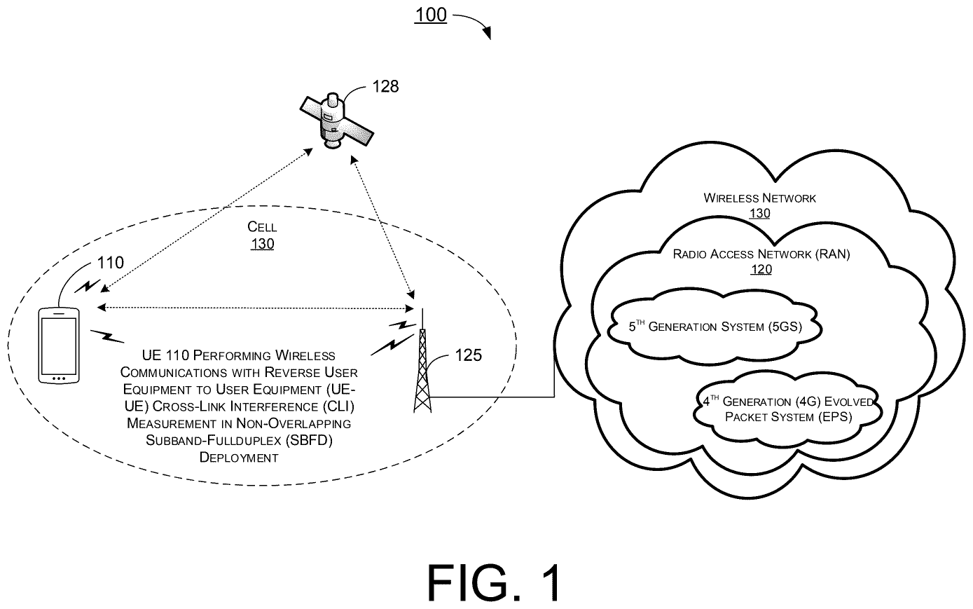

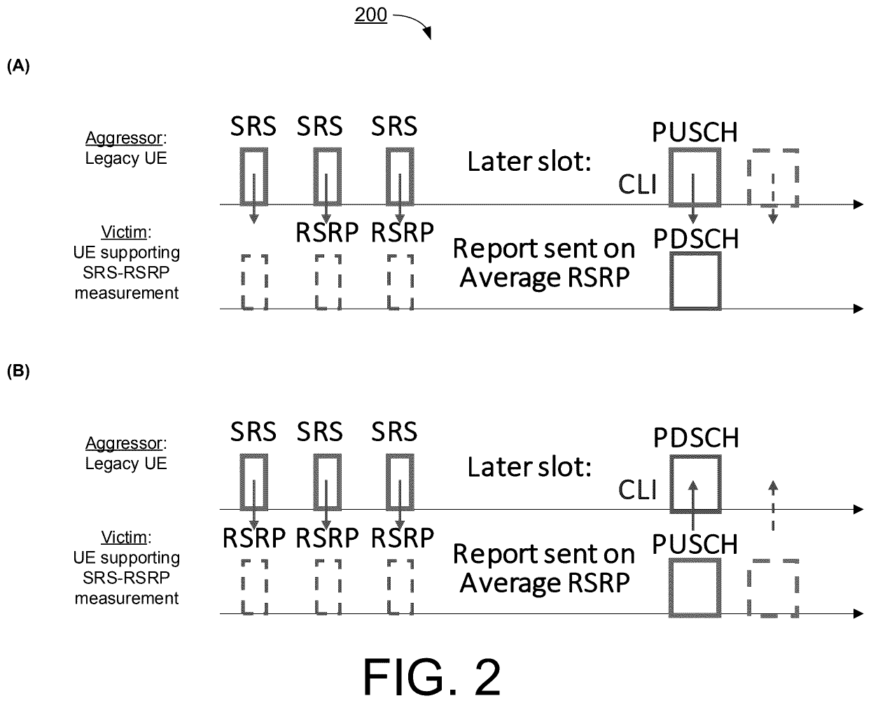

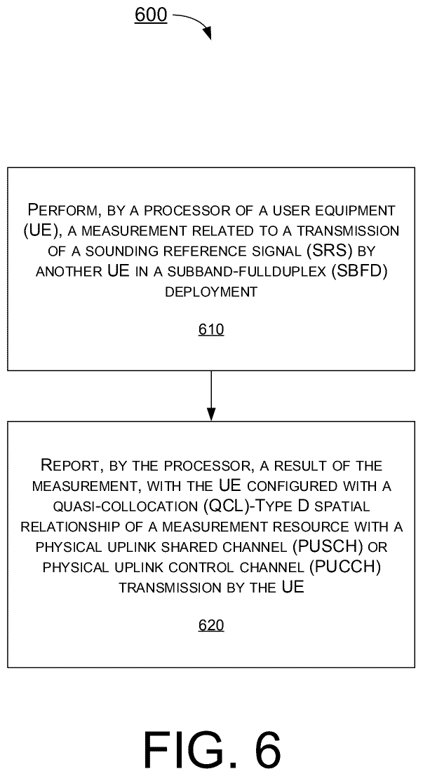

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6.

Referring to FIG. 1, network environment 100 may involve a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB or transmit-receive point (TRP)) and/or a non-terrestrial network node 128 (e.g., a satellite). RAN 120 may be a part of a network 130. In network environment 100, UE 110 and network 130 (via network node 125 of RAN 120) may implement various schemes pertaining to reverse UE-UE CLI measurement in a non-overlapping SBFD deployment, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under the proposed schemes in accordance with the present disclosure, a potential aggressor UE may perform the UE-UE CLI measurement when a legacy UE is transmitting, and the aggressor UE may report the level of CLI to the UE scheduler. That is, a SRS may be transmitted in an UL subband or UL slot by legacy UE and SRS reference signal received power (SRS-RSRP) may be measured by the legacy UE. The UE scheduler may estimate the CLI in the reverse direction (e.g., when the legacy UE is receiving and is a victim of CLI from the reporting UE) or the UE scheduler may apply it directly by assuming transmission-reception (Tx-Rx) reciprocity with respect to CLI level within the tolerances of necessary accuracy. This is herein referred to as “reverse CLI-measurement” or “reverse CLI-prediction” between UEs. Moreover, asymmetries between transmission and reception in each UE participating in CLI scenarios may need to be taken into account, and the conditions for the CLI measurements may need to be adjusted accordingly.

FIG. 2 illustrates an example scenario 200 under a proposed scheme in accordance with the present disclosure. Scenario 200 pertains to forward versus reverse CLI measurement and prediction using layer 3 (L3) SRS-RSRP. Part (A) of FIG. 2 shows an example of forward CLI prediction with fixed Tx-Rx roles and with a victim UE measuring SRS-RSRPs. In this example, periodic UE-CLI measurements may be performed and SRS-RSRP may characterize CLI between 10 each UE-pair. Moreover, in case that a reported RSRP is too high, then a scheduler may defer the aggressor UE in a different slot or symbol and the scheduler may also schedule a weaker aggressor instead. Part (B) of FIG. 2 shows an example of reverse CLI prediction using Tx-Rx CLI reciprocity with an aggressor UE measuring SRS-RSRP when a victim legacy UE has no such capability, so as preserve performance of the legacy UE. Tx-Rx reciprocity is assumed with respect to a large-scale fading and Tx and Rx antenna gains. In this example, periodic UE-CLI measurements may be performed and SRS-RSRP may characterize CLI between each UE-pair. Moreover, the same may be performed as in the example shown in part (A) of FIG. 2, using reverse CLI reports.

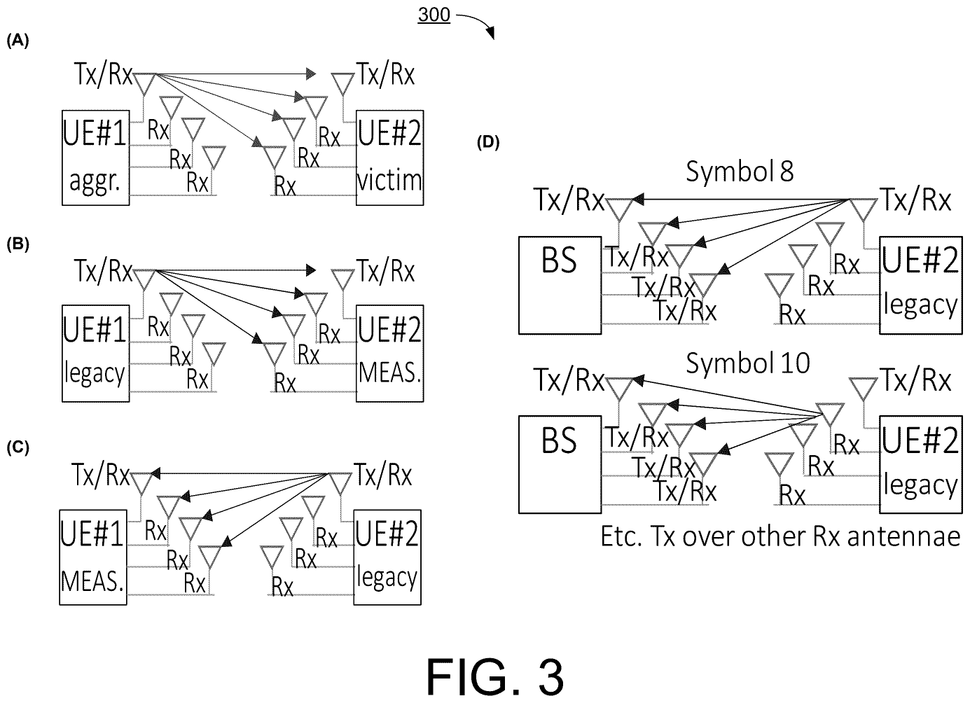

FIG. 3 illustrates an example scenario 300 under a proposed scheme in accordance with the present disclosure. Scenario 300 pertains to frequency range 1 (FR1) SRS-RSRP CLI measurement antenna configuration scenarios. Part (A) of FIG. 3 shows an example of a potential CLI scenario in which a first UE (UE #1), as the aggressor, is scheduled in a UL-SB of a DL slot, thereby causing CLI to a second UE (UE #2), as a victim. The deployment may be in FR1 (for simplicity), where analog beamforming is not used, and the number of Tx and Rx antennas is typically different. All four antennas are used in Rx but only one used in Tx in the example. The two UEs may have different numbers of antennas. (In frequency range 2 (FR2) the number of digital Tx and Rx branches may be asymmetrical in number and the proposed schemes may apply there, too, but analog beamforming may add to the complexity of the scenario.)

Part (B) of FIG. 3 shows an example of a forward CLI-measurement/prediction scenario in which UE #1 transmits SRS on a single Tx antenna. UE #2 measures SRS-RSRP over all four antennas and reports the aggregated (and L3-filtered) value to a base station (e.g., gNB). The scheduler uses this value for CLI-prediction in the scenario of part (A) of FIG. 3, where UE #1 is the aggressor and UE #2 is the victim; hence, Tx and Rx roles are identical between measurement and prediction. Regarding aggregation over Rx antennas, according to Rel-16 of 3GPP standard Technical Specification (TS) 38.215, SRS-RSRP is calculated per each antenna connector separately, and an aggregated SRS-RSRP is (filtered over several instances of the SRS-resource and) reported to gNB. The aggregated value is equal to or greater than the largest value measured over any antenna according to the standard.

Part (C) of FIG. 3 shows an example of a reverse CLI-measurement/prediction scenario in which UE #2 (e.g., a legacy device) transmits SRS on single Tx antenna and UE #1 measures SRS-RSRP over all four antennas and reports the aggregated (and L3-filtered) value to gNB. The scheduler uses this value for CLI-prediction in the scenario of part (A) of FIG. 3, where UE #1 is aggressor and UE #2 is victim; hence, Tx and Rx roles are identical between measurement and prediction.

Part (D) of FIG. 3 shows an example of a reverse measurement and prediction for local area (LA) by base station (BS) using Tx-antenna-switching. This scenario uses Tx-Rx time-division duplex (TDD) channel reciprocity in somewhat similar manner as part (C) of FIG. 3. The purpose is different, however. In part (D), the UL SRS reception by BS allows estimating DL channel state for link (e.g., channel quality indicator (CQI), precoding matrix indicator (PMI), rank indication (RI)) adaptation. Although the UE may support a single antenna port, it supports the optional feature whereby it can switch the transmission to other receive antennas (e.g., within 15 microseconds of transition duration for switching). The UE is configured with an SRS-Resource-Set containing multiple SRS-Resources, each scheduled to different symbols. The SRS-Resource-Set field ‘usage’ is configured to ‘txAntennaSwitching’. Each time SRS-Resource-Set is triggered, each of the SRS-resources is transmitted in its respective symbols and the antenna is switched between transmissions. The pattern is specified by SRS-TxSwitch field in the UE's FeatureSet. The BS measures the complex channel with respect to each antenna for multi-input-and-multi-output (MIMO) link adaptation.

There are some limitations with respect to existing L3 SRS-RSRP measurements under Rel-16 of the 3GPP specification. Comparing the scenarios depicted in part (C) of FIG. 3 (reverse-CLI measurement) and part (D) of FIG. 3 (DL channel estimation), SRS-RSRP measurement has a number of limitations when used for reverse prediction. Firstly, only the aggregate SRS-RSRP value is reported dropping the SRS-RSRP values for each antenna. Secondly, the phase information across Rx antennas is also dropped. Thirdly, unlike the case of reciprocal channel estimation where the SRS-resource-set is configured with ‘txAntennaSwitching’ and SRS-resources to be used with each antenna, the CLI-MeasObject only allows configuring a set of independent SRS-resources which will get reported on independently, too, rather than the aggregated value. See figure below. See Appendices for details. Fourthly, SRS resource trigger can only be ‘periodic’, whereas ‘semi-static’ (by MAC) and ‘aperiodic’ (by DCI) trigger is not supported. This and other limitations (like L3 reporting, no SpatialRelationshipInfo) is out of scope for some of the proposed schemes.

Accordingly, under various proposed schemes in accordance with the present disclosure, certain operations may be performed for each SRS-resource separately. For instance, SRS-RSRP per Rx branch may be measured separately for each SRS resource. Additionally, SRS-RSRP over receivers may be aggregated separated for each SRS resource. Moreover, SRS-RSRP may be filtered separately for each SRS resource. Moreover, in event-triggered cases, each trigger may be evaluated separately for each SRS resource. Also, measurement result, along with measurement identification (Meas-id) and SRS identification (SRS-id), may be reported separately for each SRS resource.

It is noteworthy that, with respect to quasi-collocation (QCL) between Rel-16 CLI measurement and DL reception in FR1 and FR2, in FR1 the physical antenna port is used for SRS-RSRP, which drops the phase. As such the measurement is not quasi-collocated with gNB transmissions in any sense. Receiver diversity is accounted for in SRS-RSRP aggregation. According to the 3GPP standard, the UE transmitting the SRS needs to use antenna port 1, which is mapped to physical antennae statically or by beam management. In FR2, the antenna port after analog Rx beamforming applied before SRS-RSRP, the phase is only dropped at that point. The measurement is spatially quasi-collocated (e.g., Type-D) with the latest gNB DL transmission (e.g., physical downlink shared channel (PDSCH) or control resource set (CORESET) monitoring). For the UE transmitting SRS, the analog Tx beam is selected by beam management. Assuming UL-DL beam correspondence, the selected Tx and Rx beams are identical. The contrary may occur, too (e.g., when the beamwidths differ, this also changes the gain and pattern of side-lobes).

During CLI measurement, the aim is to select the Rx antenna of the aggressor UE that may be transmitting in a reciprocal CLI scenario, assuming one transmitter and four receivers (1Tx4Rx) although the similar may apply to other asymmetrical cases (e.g., two transmitters and four receivers (2Tx4Rx)). FR1 L3 CLI measurement may be sufficient or proper as it is for reciprocity when small scale fading effects are filtered out by averaging over antennas and over time. When Tx-Rx roles are swapped between UEs, the number of Tx-Rx paths may be similar or the same, leading to similar averaging outcome, whereas remaining differences may further be attenuated by L3 filtering. However, FR1 CLI measurement still needs enhancements for reciprocity because the number of Tx-Rx paths may change significantly between measurement and prediction, and the Rx diversity in use by the aggressor and victim UEs may be different (e.g., legacy UE being a reduced-capability device with 1Tx1Rx). Furthermore, in case that reporting enhancement at L1 is assumed, then L3 filtering cannot be relied on and, thus, small scale fading may need to be tracked.

Additionally, phase information may be relevant for positioning by triangulation or change detection. While the precise method is not of concern in the present disclosure, reporting of the following information may be useful: (a) differences of incident angles between CLI signal and wanted DL signal; (b) incident angle with respect to antenna panel; and (c) difference of incident angle between subsequent CLI measurements.

For the receiving party, the Tx antenna switch may be transparent if the sequence of transmissions from each Tx antenna can be measured and the aggregate value can be reported. For instance, usage=‘AntennaSwitching’ may be a field of SRS-Resource-Set, whereas CLI-MeasObj configurations may point to a sequence of SRS-Resources and each one may be reported on separately instead of reporting the aggregate value over Tx antennas.

In view of the above, under a first proposed scheme in accordance with the present disclosure, a UE (e.g., UE 110) may report SRS-RSRP (or cross-link interference received signal strength indicator (CLI-RSSI)) per Rx antenna separately. Under the proposed scheme, in case that L3 filtering is performed by UE 110, then L3 filtering may be performed for each Rx antenna SRS-RSRP value separately, too. The same may apply to layer 1 (L1) reporting if that is supported. In an event that other metrics are reported (e.g., phase difference between Rx antennas, (weighted) peak value, and/or standard deviation), then such other metrics may also be reported per Rx antenna. For instance, the aggregate SRS-RSRP (or CLI-RSSI) result may also be reported. Moreover, based on UE configuration, UE 110 may select which RX antenna is measured.

Under a second proposed scheme in accordance with the present disclosure, SRS measurement resource or set of such resources configured for SRS-RSRP measurement may be configured with option to report an aggregate CLI value over an entire burst transmitted from switched Tx antennas. In a first option (Option 1), antenna switching may be performed per measurement trigger (periodic or aperiodic). The MeasObjects may support forming SRS-resource-sets with ‘antennaSwitching’ option. Switching rules and guard interval (GI) restrictions may apply just as with legacy ‘antennaSwitching’ usage of SRS-resource-set information element. In a second option (Option 2), the antenna may be switched per measurement period for SRS-resource if configured with this option. For instance, L3 filtering may apply ideal average (e.g., equal weights) between values measured over separate antenna within the latest switching period, before applying the exponential averaging defined by the standard. Alternatively, a current L3 filtering may be applied as-is despite the fact of switching. Although RSSI-CLI may not be suitable for reverse measurements, under special circumstances and with some enhancements, reverse measurements may be motivated, too.

Under the proposed scheme, CLI-RSSI measurement resource or a set of such resources configured for CLI-measurement may be configured with an option to report an aggregate CLI value over the entire burst transmitted from switched Tx antennas. In a first option (Option 1), antenna switching may be performed per measurement trigger (periodic or aperiodic). The MeasObjects may support forming CLI-RSSI-resource-sets with ‘antennaSwitching’ option. Switching rules and GI restrictions may apply just as with legacy ‘antennaSwitching’ usage of SRS-resource-set information element. In a second option (Option 2), the antenna may be switched per measurement period for CLI-RSSI-measurement-resource if configured with this option. For instance, L3 filtering may apply ideal average (e.g., equal weights) between values measured over separate antenna within the latest switching period, before applying the exponential averaging defined by the standard. Alternatively, a current L3 filtering may be applied as-is despite the fact of switching.

It is also noteworthy that there may be some Rel-16 FR2 QCL configuration requirement for reverse CLI measurement. Notably, as the victim UE transmits SRS in an uplink subband (UL-SB), the gNB needs to configure some analog Tx beamforming for SRS as the Rx analog beam used with PDSCH reception. Moreover, as the aggressor UE measures SRS-RSRP in UL-SB and CLI-RSSI in a downlink subband (DL-SB), the same analog RX beamforming (hence QCL-Type D) between CLI measurement and DL reception configurations may apply. The same Tx analog beam for PUSCH as for Rx analog beam for PDSCH may be used. In case that UL-DL beam correspondence can be assumed in the deployment, then beam management may configure the same Tx and Rx beams for both the aggressor UE and the victim UE. In the contrary case, Tx and Rx beams may be different. Therefore, in a reverse CLI measurement, the goal would be to achieve that UE transmitting the SRS uses its Rx beam and the UE measuring the SRS-RSRP uses its Tx beam. L3 filtering may help averaging out (in dB) potential variations in side-lobe gains due to notches of the pattern.

In a reverse CLI measurement scenario, a legacy UE transmitting the SRS may be configured to use its Rx beam using the SpatialRelationInfo. However, for the UE measuring the SRS-RSRP, there is no means to specify how to use its Tx beam. A new configuration option may be proposed to specify using the Tx beam for the measurement instead of using the Rx beam. Under a third proposed scheme in accordance with the present disclosure, a UE measuring SRS-RSRP may be configured with QCL-Type D spatial relationship with its PUSCH or PUCCH transmission. For instance, the SRS resource configured as measurement resource may be configured with a SpatialRelationInfo. The SpatialRelationInfo may be restricted to be configured with an SRS resource as a reference signal. Alternatively, a new field may be introduced (below MeasObjCLI or reportConfig) that allows indicating reverse measurement or usage of the analog Tx beam. This feature may be restricted to FR2. Moreover, the UE measuring the SRS-RSRP may follow QCL-Type D spatial relationship according to QCL assumption associated with its (latest) PUSCH or PUCCH transmission.

### Illustrative Implementations

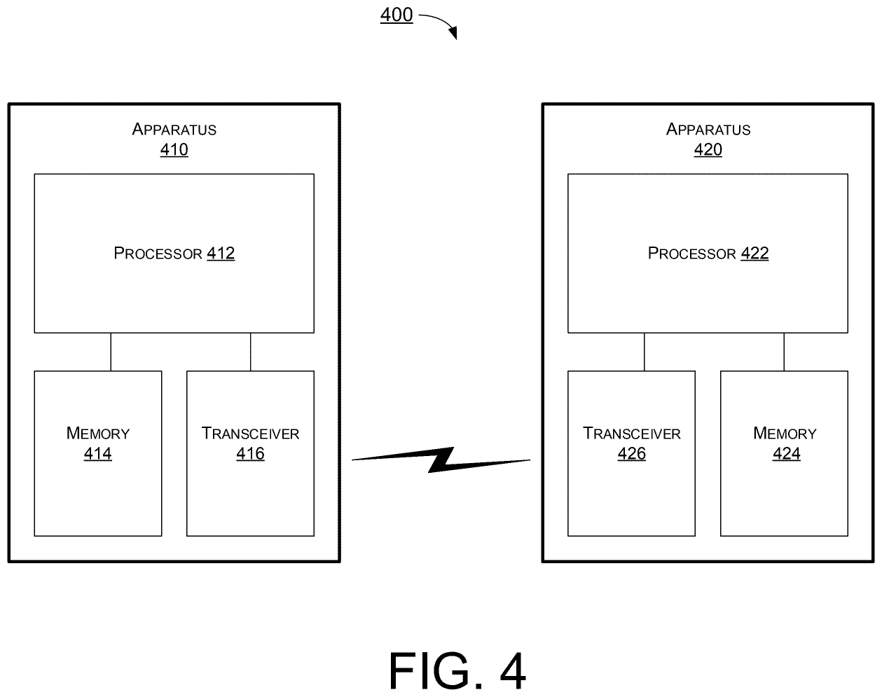

FIG. 4 illustrates an example communication system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to reverse UE-UE CLI measurement in a non-overlapping SBFD deployment, including the various schemes described above with respect to various proposed designs, concepts, schemes, systems and methods described above, including network environment 100, as well as processes described below.

Each of apparatus 410 and apparatus 420 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 410 and apparatus 420 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in an eNodeB in an LTE, LTE-Advanced or LTE-Advanced Pro network or in a gNB or TRP in a 4G network, an NR network or an IoT network.

In some implementations, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to reverse UE-UE CLI measurement in a non-overlapping SBFD deployment in accordance with various implementations of the present disclosure.

In some implementations, apparatus 410 may also include a transceiver 416 coupled to processor 412. Transceiver 416 may be capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs/wireless networks of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as a UE (e.g., UE 110), and apparatus 420, as a network node (e.g., network node 125) of a network (e.g., network 130 as a 5G/NR mobile network), is provided below.

Under some of the proposed schemes in accordance with the present disclosure pertaining to reverse UE-UE CLI measurement in a non-overlapping SBFD deployment, processor 412 of apparatus 410, implemented in or as UE 110, may perform, via transceiver 416, a measurement related to a transmission by another UE (e.g., apparatus 420) in a SBFD deployment. Moreover, processor 412 may report, via transceiver 416, a result of the measurement per Rx antenna of a plurality of Rx antennas separately.

In some implementations, in performing the measurement, processor 412 may perform a SRS-RSRP measurement. In some implementations, in reporting the result of the measurement, processor 412 may report an aggregate of SRS-RSRP results. In some implementations, processor 412 may further perform a L3 filtering per Rx antenna SRS-RSRP value separately. Alternatively, or additionally, processor 412 may further perform a L1 filtering per Rx antenna SRS-RSRP value separately.

In some implementations, in performing the measurement, processor 412 may perform a CLI-RSSI measurement. In some implementations, in reporting the result of the measurement, processor 412 may further report an aggregate of CLI-RSSI results.

In some implementations, in reporting the result of the measurement, processor 412 may report one or more other metrics on a per-Rx antenna basis. For instance, the one or more other metrics may include at least one of a phase difference between the plurality of Rx antennas, a peak value, a weighted peak value, and a standard deviation.

In some implementations, in performing the measurement, processor 412 may select which Rx antenna of the plurality of Rx antennas to be measured based on a UE configuration.

In some implementations, in performing the measurement, processor 412 may perform the measurement in FR1.

Under other proposed schemes in accordance with the present disclosure pertaining to reverse UE-UE CLI measurement in a non-overlapping SBFD deployment, processor 412 of apparatus 410, implemented in or as UE 110, may perform, via transceiver 416, via transceiver 416, a measurement related to a transmission of a SRS by another UE (e.g., apparatus 420) in a SBFD deployment. Additionally, processor 412 may report, via transceiver 416, a result of the measurement. Apparatus 410, as the UE, may be configured with a QCL-Type D spatial relationship of a measurement resource with a PUSCH or PUCCH transmission by apparatus 410.

In some implementations, in performing the measurement, processor 412 may perform the measurement using a SRS resource configured as the measurement resource. Moreover, the SRS resource may be configured with spatial relation information (SpatialRelationInfo). In some implementations, the SpatialRelationInfo may be configured with the SRS resource as a reference signal.

In some implementations, in reporting the result of the measurement, processor 412 may report with a new field that indicates a reverse measurement. Alternatively, in reporting the result of the measurement, processor 412 may report with the new field that indicates usage of an analog Tx beam.

In some implementations, in performing the measurement, processor 412 may perform the measurement in FR2.

### Illustrative Processes

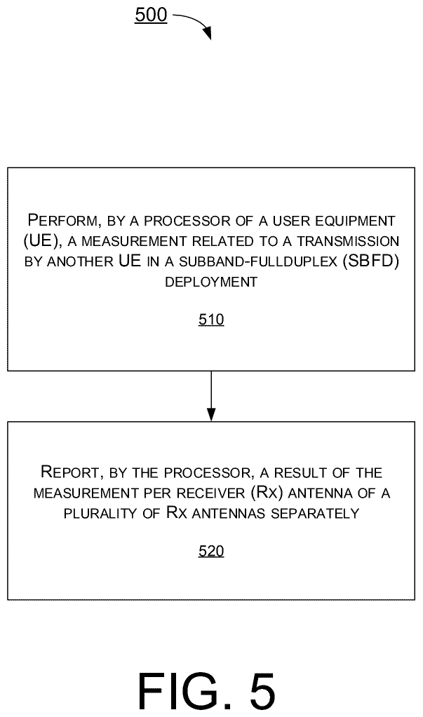

FIG. 5 illustrates an example process 500 in accordance with an implementation of the present disclosure. Process 500 may represent an aspect of implementing various proposed designs, concepts, schemes, systems and methods described above, whether partially or entirely, including those pertaining to those described above. More specifically, process 500 may represent an aspect of the proposed concepts and schemes pertaining to reverse UE-UE CLI measurement in a non-overlapping SBFD deployment. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 410 and apparatus 420 as well as any variations thereof. Solely for illustrative purposes and without limiting the scope, process 500 is described below in the context of apparatus 410 as a UE (e.g., UE 110) and apparatus 420 as a communication entity such as a network node or base station (e.g., network node 125 network node 125) of a network (e.g., network 130 as a 5G/NR mobile network). Process 500 may begin at block 510.

At 510, process 500 may involve processor 412 of apparatus 410 performing, via transceiver 416, a measurement related to a transmission by another UE (e.g., apparatus 420) in a SBFD deployment. Process 500 may proceed from 510 to 520.

At 520, process 500 may involve processor 412 reporting, via transceiver 416, a result of the measurement per Rx antenna of a plurality of Rx antennas separately.

In some implementations, in performing the measurement, process 500 may involve processor 412 performing a SRS-RSRP measurement. In some implementations, in reporting the result of the measurement, process 500 may further involve processor 412 reporting an aggregate of SRS-RSRP results. In some implementations, process 500 may further involve processor 412 performing a L3 filtering per Rx antenna SRS-RSRP value separately. Alternatively, or additionally, process 500 may further involve processor 412 performing a L1 filtering per Rx antenna SRS-RSRP value separately.

In some implementations, in performing the measurement, process 500 may involve processor 412 performing a CLI-RSSI measurement. In some implementations, in reporting the result of the measurement, process 500 may further involve processor 412 reporting an aggregate of CLI-RSSI results.

In some implementations, in reporting the result of the measurement, process 500 may involve processor 412 reporting one or more other metrics on a per-Rx antenna basis. For instance, the one or more other metrics may include at least one of a phase difference between the plurality of Rx antennas, a peak value, a weighted peak value, and a standard deviation.

In some implementations, in performing the measurement, process 500 may involve processor 412 selecting which Rx antenna of the plurality of Rx antennas to be measured based on a UE configuration.

In some implementations, in performing the measurement, process 500 may involve processor 412 performing the measurement in FR1.

FIG. 6 illustrates an example process 600 in accordance with an implementation of the present disclosure. Process 600 may represent an aspect of implementing various proposed designs, concepts, schemes, systems and methods described above, whether partially or entirely, including those pertaining to those described above. More specifically, process 600 may represent an aspect of the proposed concepts and schemes pertaining to reverse UE-UE CLI measurement in a non-overlapping SBFD deployment. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively.

Process 600 may be implemented by or in apparatus 410 and apparatus 420 as well as any variations thereof. Solely for illustrative purposes and without limiting the scope, process 600 is described below in the context of apparatus 410 as a UE (e.g., UE 110) and apparatus 420 as a communication entity such as a network node or base station (e.g., network node 125 network node 125) of a network (e.g., network 130 as a 5G/NR mobile network). Process 600 may begin at block 610.

At 610, process 600 may involve processor 412 of apparatus 410 performing, via transceiver 416, a measurement related to a transmission of a SRS by another UE (e.g., apparatus 420) in a SBFD deployment. Process 600 may proceed from 610 to 620.

At 620, process 600 may involve processor 412 reporting, via transceiver 416, a result of the measurement. Apparatus 410, as the UE, may be configured with a QCL-Type D spatial relationship of a measurement resource with a PUSCH or PUCCH transmission by apparatus 410.

In some implementations, in performing the measurement, process 600 may involve processor 412 performing the measurement using a SRS resource configured as the measurement resource. Moreover, the SRS resource may be configured with spatial relation information (SpatialRelationInfo). In some implementations, the SpatialRelationInfo may be configured with the SRS resource as a reference signal.

In some implementations, in reporting the result of the measurement, process 600 may involve processor 412 reporting with a new field that indicates a reverse measurement. Alternatively, in reporting the result of the measurement, process 600 may involve processor 412 reporting with the new field that indicates usage of an analog Tx beam.

In some implementations, in performing the measurement, process 600 may involve processor 412 performing the measurement in FR2.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of a user equipment (UE), a measurement related to a transmission by another UE in a subband-fullduplex (SBFD) deployment; and
reporting, by the processor, a result of the measurement per receiver (Rx) antenna of a plurality of Rx antennas separately.

2. The method of claim 1, wherein the performing of the measurement comprises performing a sounding reference signal reference signal received power (SRS-RSRP) measurement.

3. The method of claim 2, wherein the reporting of the result of the measurement further comprises reporting an aggregate of SRS-RSRP results.

4. The method of claim 2, further comprising:
performing, by the processor, a layer 3 (L3) filtering per Rx antenna SRS-RSRP value separately.

5. The method of claim 2, further comprising:
performing, by the processor, a layer 1 (L1) filtering per Rx antenna SRS-RSRP value separately.

6. The method of claim 1, wherein the performing of the measurement comprises performing a cross-link interference received signal strength indicator (CLI-RSSI) measurement.

7. The method of claim 6, wherein the reporting of the result of the measurement further comprises reporting an aggregate of CLI-RSSI results.

8. The method of claim 1, wherein the reporting of the result of the measurement comprises reporting one or more other metrics on a per-Rx antenna basis, and wherein the one or more other metrics comprise at least one of a phase difference between the plurality of Rx antennas, a peak value, a weighted peak value, and a standard deviation.

9. The method of claim 1, wherein the performing of the measurement comprises selecting which Rx antenna of the plurality of Rx antennas to be measured based on a UE configuration.

10. The method of claim 1, wherein the performing of the measurement comprises performing the measurement in frequency range 1 (FR1).

11. A method, comprising:
performing, by a processor of a user equipment (UE), a measurement related to a transmission of a sounding reference signal (SRS) by another UE in a subband-fullduplex (SBFD) deployment; and
reporting, by the processor, a result of the measurement,
wherein the UE is configured with a quasi-collocation (QCL)-Type D spatial relationship of a measurement resource with a physical uplink shared channel (PUSCH) or physical uplink control channel (PUCCH) transmission by the UE.

12. The method of claim 11, wherein the performing of the measurement comprises performing the measurement using a SRS resource configured as the measurement resource, and wherein the SRS resource is configured with spatial relation information (SpatialRelationInfo).

13. The method of claim 12, wherein the SpatialRelationInfo is configured with the SRS resource as a reference signal.

14. The method of claim 11, wherein the reporting of the result of the measurement comprises reporting with a new field that indicates a reverse measurement.

15. The method of claim 11, wherein the reporting of the result of the measurement comprises reporting with a new field that indicates usage of an analog transmission (Tx) beam.

16. The method of claim 11, wherein the performing of the measurement comprises performing the measurement in frequency range 2 (FR2).

17. An apparatus implementable in a user equipment (UE), comprising:
a transceiver configured to communicate wirelessly; and
a processor coupled to the transceiver and configured to perform, via the transceiver, operations comprising:
performing a measurement related to a transmission by another UE in a subband-fullduplex (SBFD) deployment; and
reporting a result of the measurement per receiver (Rx) antenna of a plurality of Rx antennas separately.

18. The apparatus of claim 17, wherein the performing of the measurement comprises performing a sounding reference signal reference signal received power (SRS-RSRP) measurement.

19. The apparatus of claim 18, wherein the UE is configured with a quasi-collocation (QCL)-Type D spatial relationship with a physical uplink shared channel (PUSCH) or physical uplink control channel (PUCCH) transmission by the UE.

20. The apparatus of claim 17, wherein the performing of the measurement comprises performing a cross-link interference received signal strength indicator (CLI-RSSI) measurement.
